(19) United States
(12) Patent Application Publication
(10) Pub. No.: US 2017/0154323 A1
(43) Pub. Date: Jun. 1, 2017

(54) SYSTEM AND METHOD FOR REPORTING CURRENCY TRANSACTIONS

(71) Applicants: Quentin G. Bohrer, Denton, TX (US); Prashant X. Khanijo, Bangalore (IN); Narayanan Satyamurthy, Bangalore (IN); Sony Thomas, Bangalore (IN); Mohammed A. Qureshi, Bangalore (IN); Francina Vijay Latha, Bangalore (IN)

(72) Inventors: Quentin G. Bohrer, Denton, TX (US); Prashant X. Khanijo, Bangalore (IN); Narayanan Satyamurthy, Bangalore (IN); Sony Thomas, Bangalore (IN); Mohammed A. Qureshi, Bangalore (IN); Francina Vijay Latha, Bangalore (IN)

(21) Appl. No.: 12/627,342

(22) Filed: Nov. 30, 2009

(51) Int. Cl. G06Q 20/00; G06Q 40/00; G06F 17/30; G06Q 10/00

(52) U.S. Cl. CPC G06Q 20/22

(57) ABSTRACT

According to one embodiment, the invention comprises a currency transaction reporting system that includes a first database embodied on a general purpose computer that organizes and stores on a computer readable medium one or more currency transaction reports; a rules engine connected to the first database by the telecommunications network, that receives the one or more currency transaction reports from the first database and divides the one or more currency transaction reports into a first group and a second group; a load balancing engine connected to the rules engine by the telecommunications network, that receives the one or more currency transaction reports of the first group and assigns the one or more currency transaction reports of the first group; and one or more workstations that receive the assigned one or more currency transaction reports and electronically attach notes and supporting documentation to the one or more currency transaction reports to create one or more supported currency transaction reports.

### FIELD OF THE INVENTION

System and methods relate, generally, to currency transaction reporting, and more specifically, to a system and method for creating a supported currency transaction report that may be filed with a regulatory agency.

### BACKGROUND OF THE INVENTION

Financial institutions are required to file a report with a regulatory agency for each deposit of currency, withdrawal of currency, exchange of currency, or other payment or transfer, by, through, or to the financial institution, where the transaction (or series of transactions) is greater than a threshold amount. These reports are commonly referred to as Currency Transaction Reports (CTRs). The regulatory agency may use the CTR for any number of reasons, but one of the primary reasons is to detect fraud or money laundering activities.

Most financial intuitions generate the CTR automatically, upon transacting with currency (in one or a series of transactions) for an amount greater than the threshold. Traditionally, the generated CTRs are uploaded to a main frame by the financial institutions, and then reviewed before filing with the appropriate regulatory agency. Often, CTRs require supporting documentation, notations that explain the transaction and the supporting documentation, etc., Thus, the CTRs are downloaded each day from the main frame, reviewed, supporting documentation attached (often paper-clipped) and then the entire paper document is filed with the regulatory agency. Research is often performed by researchers, who receive a stack of CTRs, perhaps on a daily basis, separate the CTRs that require further research, supporting documentation, and/or notations, and prepare the supported CTR.

The entire process needs to be performed in a secure manner, that is, there is always a risk that the CTRs could be altered, that confidential information could be released, etc., thus, the entire process is performed with redundancy and logging, to maintain the high quality standards.

The expectation is absolute perfection. Currency Transactions must be detected and filed with 100% accuracy. Thus, a system that reduces the number of “touches” that could alter the CTRs or expose confidential information, or in any other manner reduce the quality of the filing so that it is not considered 100% accurate, is desirable.

There is also a need for an efficient system to review the CTRs and add supporting documentation and notes to the CTRs. Further, there is a need for an efficient system that assigns CTRs to researchers, having already culled out the CTRs that do not require further research, such that the researchers may conduct the research necessary to support the remaining CTRs. Further, there is a need for a system that operates in a secure environment, such that redundancy and logging can be reduced or even eliminated.

Other technical problems and needs exist.

### BRIEF SUMMARY OF THE INVENTION

In accordance with exemplary embodiments of the present invention, there is provided a currency transaction reporting system that operates over a telecommunications network. The a currency transaction reporting system includes a first database embodied on a general purpose computer that organizes and stores on a computer readable medium one or more currency transaction reports; a rules engine connected to the first database by the telecommunications network, that receives the one or more currency transaction reports from the first database and divides the one or more currency transaction reports into a first group and a second group; a load balancing engine connected to the rules engine by the telecommunications network, that receives the one or more currency transaction reports of the first group and assigns the one or more currency transaction reports of the first group; and one or more workstations that receive the assigned one or more currency transaction reports and electronically attach notes and supporting documentation to the one or more currency transaction reports to create one or more supported currency transaction reports.

There is further provided a computer implemented method for creating a supported currency transaction report. The computer implemented method for creating a supported currency transaction report includes receiving a currency transaction report, wherein the receipt is based on a research determination by a rules engine; and electronically attaching by a first computer one or more of notations and support documents to the currency transaction report.

### BRIEF DESCRIPTION OF THE DRAWINGS

FIG. 1 is a block diagram illustrating an exemplary embodiment of the present invention.

FIG. 2 is a block diagram illustrating an exemplary embodiment of the present invention.

FIG. 3 is a block diagram illustrating an exemplary embodiment of the present invention.

FIG. 4 is a block diagram illustrating an exemplary embodiment of the present invention.

FIG. 5 is a flow chart illustrating an exemplary operation of the present invention.

FIGS. 6A and 6B are flow charts illustrating an exemplary operation of the present invention.

### DETAILED DESCRIPTIONS OF EXEMPLARY EMBODIMENTS

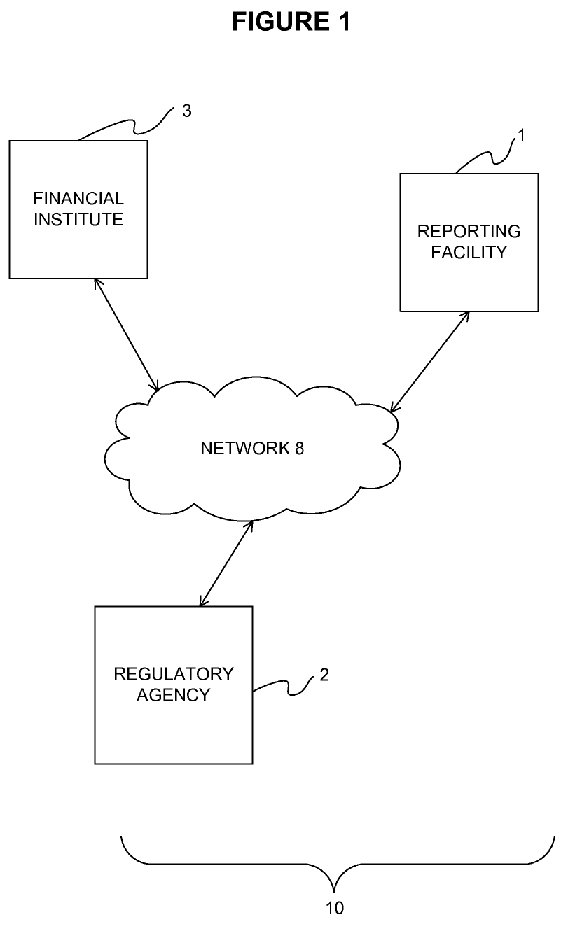

FIG. 1 illustrates a Currency Transaction Reporting System 10 according to an exemplary embodiment of the present invention. The Currency Transaction Reporting System 10 includes a Reporting Facility 1, a Regulatory Agency 2, and a Financial Institution 3. The Reporting Facility 1, a Regulatory Agency 2, and a Financial Institution 3 are connected through a communications medium over a Network 8, such as the internet, an intranet, a local-area-network (LAN), a wide-area-network (WAN), etc.

The Financial Institution 3 is, for example, a deposit bank, investment bank, brokerage house, underwriter, credit union, savings and loan association, insurance association, or any deposit taking or currency dispensing institution.

The Regulatory Agency 2, may be a governmental or quasi-governmental agency, organization, department, etc., such as the United States Treasury department, Federal Bureau of Investigation, the International Revenue Service, etc. In either example, the Regulatory Agency 2, is the agency responsible for any one of reviewing, investigating, and enforcing currency transactions.

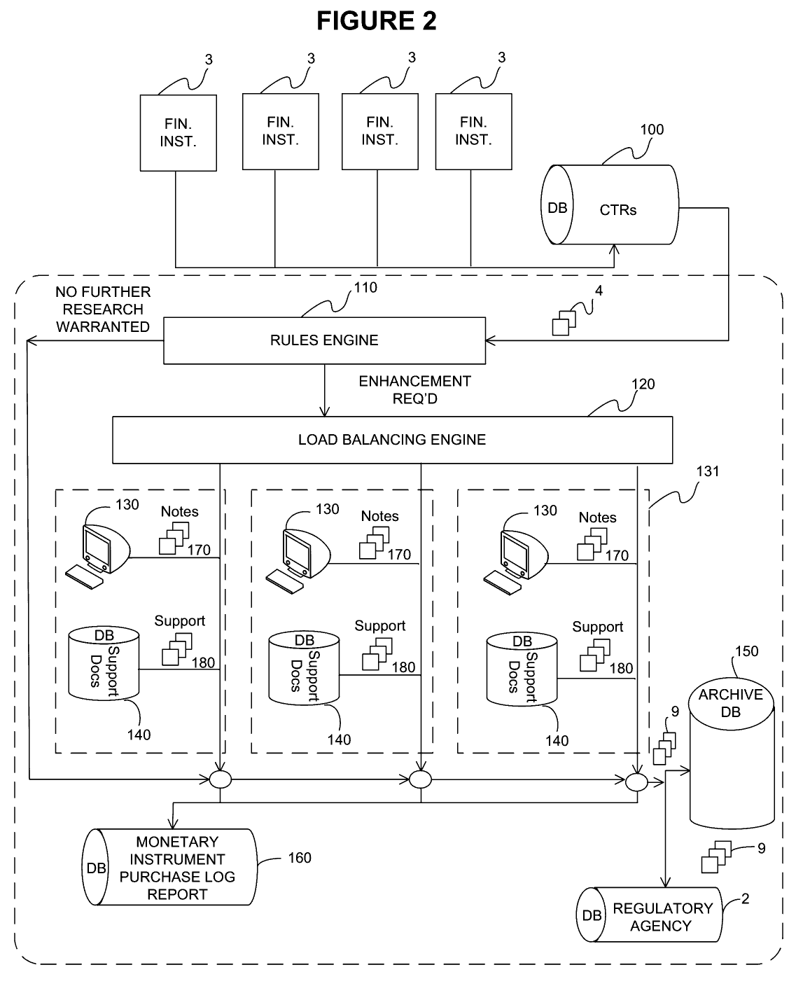

The Reporting Facility 1, may filter, review, investigate, format, and file currency transaction reports of transactions at, for example the Financial Institution 3, for example, with the Regulatory Agency 2. An exemplary embodiment of the Reporting Facility 1 is described with regard to FIG. 2.

FIG. 2 is an exemplary embodiment of the Currency Transaction Reporting System 10. This exemplary embodiment of the Currency Reporting System 10 may include, Financial Institutions 3, Currency Transaction Report Database 100, Rules Engine 110, Load Balancing Engine 120, Workstations 130, Support Document Databases 140, Monetary instrument Purchase Log Report Database 160, Archiving Database 150, and the Regulatory Agency 2. The Workstations 130 and Supporting Document Database 140 operate within a Secure Environment 131.

The elements of the Currency Transaction Reporting System 10 will now be described with reference to FIG. 2.

The Currency Transaction Report Database 100 may store Currency Transaction Reports 4, uploaded by the Financial Institutions 3. The Currency Transaction Report Database 100 may be connected to the Financial Institutions 3, locally, or remotely. In the case where the Currency Transaction Report Database 100 is connected to the Financial Institution 3, locally, the Currency Transaction Report Database 100 may reside, for example, in computer. In the case where the Currency Transaction Report Database 100 is connected to the Financial Institution 3, remotely, the Currency Transaction Report Database 100 may reside in a server. The Currency Transaction Report Database 100 may be, for example, part of a storage-area-network (SAN), or alternatively, network-attached-storage (NAS).

The Rules Engine 110 includes processors that may filter Currency Transaction Reports 4, for example, the Currency Transaction Reports 4 stored on the Currency Transaction Report Database 100. The Rules Engine 110 may filter the Currency Transaction Reports 4 according to rules logic of the Rules Engine 110. The rules logic may be implemented in hardware, for example, as digital circuits; or as software, for example, as computer executable software instructions implemented or executed by computer hardware. The exact implementation in hardware or software is largely a manner of design choice, and within the knowledge and creativity of those having ordinary skill in the art.

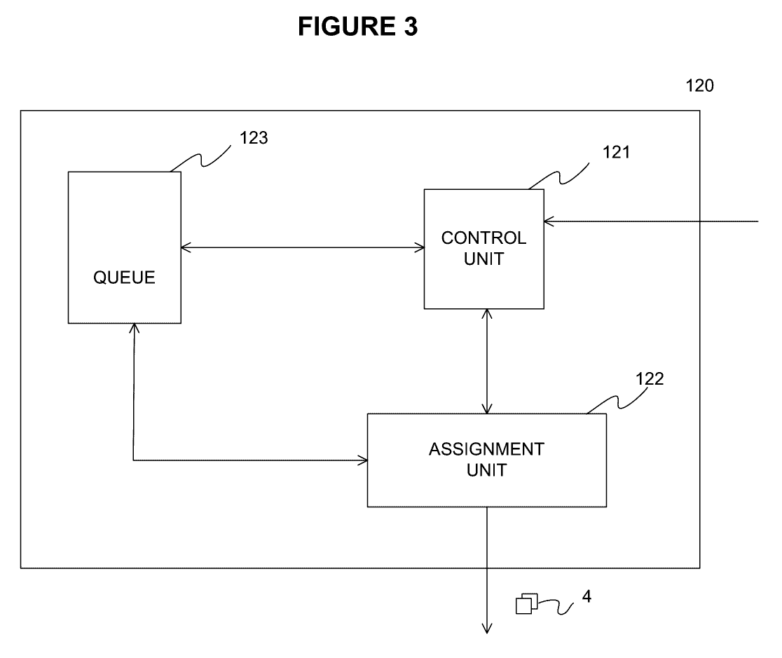

The Load Balancing Engine 120 includes processors that may balance the load on the Workstations 130. The Load Balancing Engine 120 is illustrated in FIG. 3 according to an exemplary embodiment of the present invention. The Load Balancing Engine 120 may include a Control Unit 121, a Queue 123, and an Assignment Unit 122. Each of the Control Unit 121, Queue 123, and Assignment Unit 122, may be a general purpose computer, hardware processors or co-processors in a general purpose computer, software processes running on the aforementioned general purpose computer, or hardware processors or co-processors in a general purpose computer. The Queue 123 maintains a list of Workstation 130 that may be assigned a CTR 4. The Assignment Unit 122 receives an identification from the Queue 123 of the Workstation 130 to receive the next CTR 4. The Control Unit 121 controls the Queue 123 and the Assignment Unit 122. The Control Unit 121 orders and re-orders the list of workstations maintained by the Queue 123 according to the particular load balancing protocol implemented by the Control Unit 121.

According to one exemplary embodiment, the load balancing protocol implemented by the Control Unit 121 may be a round robin protocol, assigning CTR's to each workstation in equal portions and in circular order, without priority. According to another exemplary embodiment, the load balancing protocol implemented by the Control Unit 121 may be a weighted round robin protocol. According to yet another exemplary embodiment, the load balancing protocol implemented by the Control Unit 121 may be priority based protocol that takes into account one or more of an average research time of a work station, current load of a Workstation 130, a quality rating of a Workstation 130, a relevant work history of a Workstation 130, a geographic location of a Workstation, 13 etc. The current load of a Workstation 130 refers to the current number of CTRs 4 assigned to a specific Workstation 130, or a measure of the computational difficulty of the CTRs 4 assigned to the specific Workstation 130. The quality rating could be a value representative of the errors experienced at a particular Workstation 130. The relevant work history of a Workstation 130 could include the particular type of underlying transactions that have been researched in the past at a particular Workstation 130.

The Control Unit 121 may also implement more than one load balancing protocol. For example, the Control Unit 121 may maintain a list on the Queue 123 of workstations to perform research on generic, “run-of-the-mill” CTRs, that operates under a round robin load balancing protocol; and maintain a second list on the Queue 123 of Workstations 130 to perform research on CTRs 4 that are deemed unusual, specialty, urgent, or computationally difficult, that operates under a dynamic protocol. The Control Unit 121 passes the CTR 4 to the Assignment Unit 122, and communicates to the Queue 123 to provide the ID for the Workstation 130 to the Assignment Unit 122. The Assignment Unit 122 then assigns/transmits the CTR 4 to the assigned Workstation 130.

As illustrated in FIG. 2, also included in the Currency Transaction Reporting System 10 is a Monetary Instrument Purchase Log Report 160 and an Archive Database 150. The Monetary Instrument Purchase Log Report 160 keeps a log of all researchable transactions. The Archive Database 150 is used to store all of the supported CTRs 9.

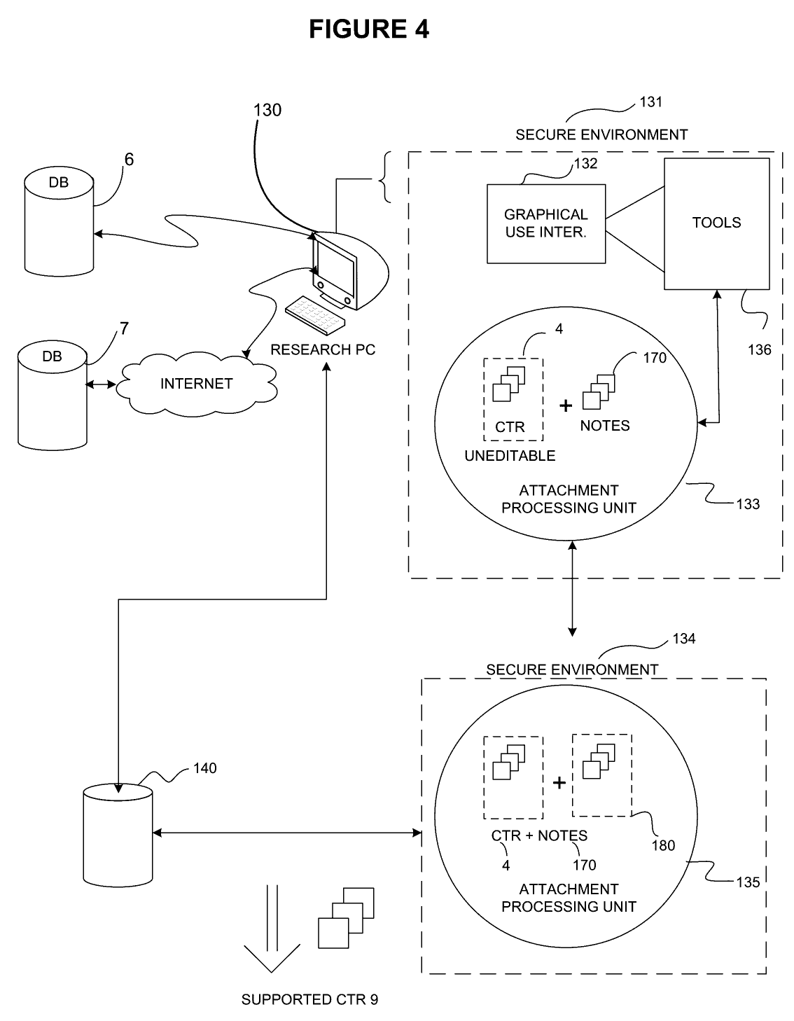

An exemplary embodiment of the Workstations 130 and Support Document Databases 140 will now be described with reference to FIG. 4.

The Workstation 130 operates under a Secure Environment 131, and is connected to a Private Database 6, and a Public Database 7. The Workstation 130 may be connected to the Private Database 6 remotely or locally. In the case where the Private Database 6 is connected to the Workstation 130, locally, the Private Database 6 may reside, for example, in computer on a LAN. In the case where the Private Database 6 is connected to the Workstation 130, remotely, the Private Database 6 may reside in a server. The Private Database 6 may be, for example, part of a storage-area-network (SAN), or alternatively, network-attached-storage (NAS).

The Workstation 130, according to this exemplary embodiment, is connected to the Public Database 7 via a network, such as LAN, WAN or the Internet. The Workstation 130 operates under a Secure Environment 131. Operating within the Secure Environment 131 are a Graphical User Interface 132 and an Attachment Processing Unit 133. The Secure Environment 131 is “secure” in several ways. The Secure Environment 131 monitors access to the CTR 4, access to the Public Database 6 and the Private Database 7. The Secure Environment 131 may be implemented at the operating system level of the Workstation 130. In the case where the Secure Environment 131 is implemented at the operating system level, it controls (i.e., grants or denies access) to secure objects such as files and file directories (e.g., confidential data), computer ports operating under specific protocols (e.g., User Datagram Protocol (UDP), Transmission Control Protocol (TCP), Internet Protocol (IP), Venturi Transport Protocol (VTP), Fibre Channel Protocol (FCP), and Steam Control Transmission Protocol (SCTP)), shared memory segments, etc. In order access the secure objects, a process must have the proper credentials. The Secure Environment 132 may also limit the operations that may be performed on any secure objects.

Herein, a “process” refers, generally, to the execution, by a processor, of software instructions. A process may consist of multiple ‘daughter’ sub-processes, that execute in parallel. The daughter processes may have the credential of the parent process, or may have their own credentials. A process may also be known by those of ordinary skill in the art as a “thread”.

The Secure Environment 131 may also be implemented to secure the Private Database 6. In such a case, access to tables, objects, procedures (i.e., database calls), etc., may be controlled.

Another aspect of the Secure Environment 131 according to an exemplary embodiment of the present invention, may be the use of cryptology.

Another aspect of the Secure Environment 131 according to an exemplary embodiment of the present invention, may be the use of various detection systems, such as virus protect programs, that limit the harmful impact of malicious software that may be acquired over the internet, and accessing public databases.

In the Secure Environment 131, a user of the Workstation 130 interacts with the Workstation 130, and thus the CTR 4, via a Graphical User Interface 132. The Graphical User Interface 132 allows the user to access Tools 136. Tools 136 are used to access the Public Database 7 and the Private Database 6, for accessing restricted information, creating Notes 170, and attaching Notes 170 to the CTR 4 via the Attachment Processing Unit 133.

Tools 136 may be a software application implemented on the Workstations 130, or Tools 136 may be a network application that is hosted on a server and accessed remotely by the Workstation 130. Utilities of the Tools 136 include generating Notes 170, accessing Public Database 7 and Private Database 6, communicating with Supporting Documents Database 140, and initiating electronic attachment of the Notes 170 and Supporting Documents 180 to the CTRs 4. Notes 170 may be a text file (e.g., .txt) or a text document such as those created by Word™ (e.g., .doc, .docx etc.), WordPerfect™ (e.g., .wpd, etc), OpenOffice Writer (e.g., .odf and other XML based document formats). Notes 170 may also be, for example an image created from an imaging tool used to take a snap shot of information stored on the Public Database 7 or Private Database 6.

Support Documents 180 may also include images created by an imaging tool as well as financial documents, applications or forms, bank checks, deposit slips, e-mails, etc. In many cases, the Support Documents 180 will be documentation that verifies that a transaction occurred.

Information on the Public Database 7 and the Private Database 6 may be used to create the Notes 170. Information on the Private Database 6 may include, for example, copies of financial instruments (e.g., bank checks), deposit slips, tax identification information, and other information for tracking or verifying currency transactions, or for tracking the identify of a bank customer.

In addition to the Secure Environment 131, there may be a Secure Environment 134. Within the Secure Environment 134 operates that Attachment Processing Unit 135. The Secure Environment 134 controls access to the Supporting Documents Database 140, and within the Secure Environment 134 may be implemented the Attachment Unit 135. The Workstation 130 may also be connected to the Supporting Documents Database 140 by a communications medium. Via the Workstation 130, Graphical User Interface 132, and Tools 136, a user may identify supporting documents stored in the Supporting Documents Database 140, that may be attached to both the CTR 4 and Notes 170 by the Attachment Unit 135. Although described separately, the Secure Environments 131 and 135 may be the same logical entity.

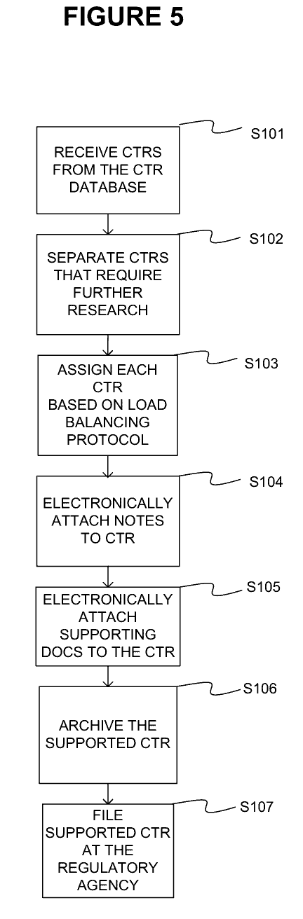

An exemplary operation of the Currency Transaction Reporting System 10 is illustrated in FIG. 5, with reference to FIG. 2. First, CTRs 4 are downloaded from the CTR Database 100 (Step S101). The Rules Engine 110 separates out the CTRs 4 that require further research (Step S102). The separated CTRs 4 are provided to the Load Balancing Engine 120 which assigns the CTRs 4 to Workstations 130, according to the particular protocol implemented thereon (Step S103). Once each Workstation 130 has received the assigned CTRs 4, Notes 170, if any, based on research may be electronically attached to the CTRs 4 (Step S104). Next, Supporting Documents 180, if any, may be electronically attached to the CTRs 4 and, if any, Notes 170 (Step S105). Once the Support Documents 180 and Notes 170, if any, are electronically attached to the CTRs 4, then the set of the CTRs 4, Support Documents 180, and Notes 170 may be stored in the Archival Database 150 (Step S106). Finally, the fully supported CTRs 9 (i.e., CTRs 4 now associated with the electronically attached Notes 170 and Support Documents 180 in the Archival Database 150) may be filed with the Regulatory Agency 2 (Step S107). According to an exemplary embodiment of the present invention, CTR 4, Notes 170 and Support Documents 180 are stored in the Archival Database 150, for example, as a .tff, .pdf, text or another form. In this exemplary embodiment, the Archival Database 150 is an SQL (structured query language) database, and the CTR 4, Notes 170 and Support Documents 180 are electronically attached by storing in a record associated with the CTR 4. The CTR 4 is not necessarily stored with the Notes 170 and Support Documents 180 and may simply be associated with the record in the SQL database.

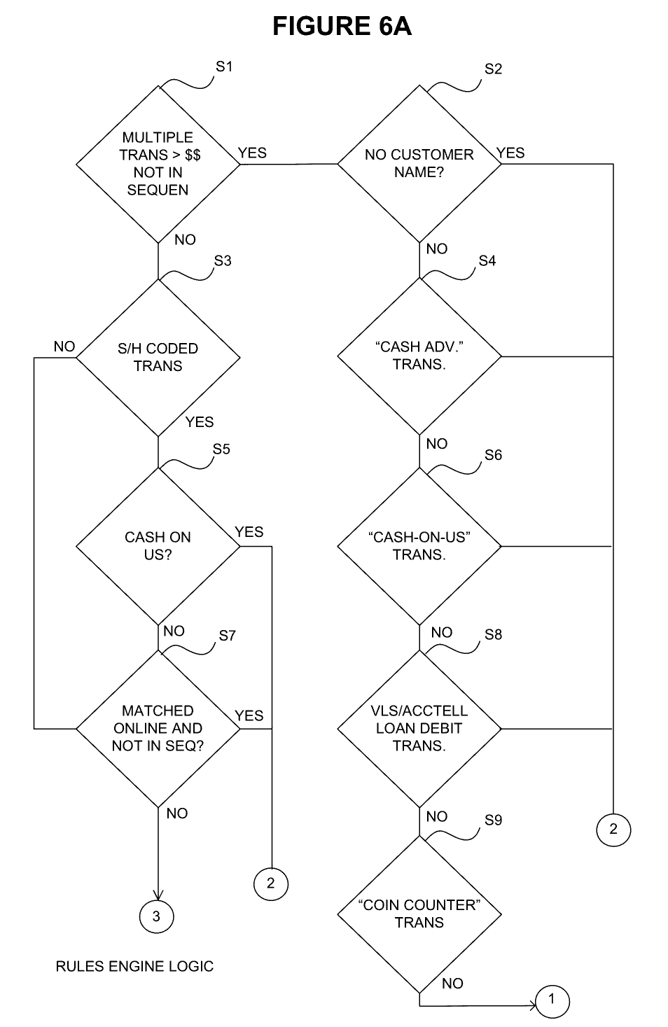

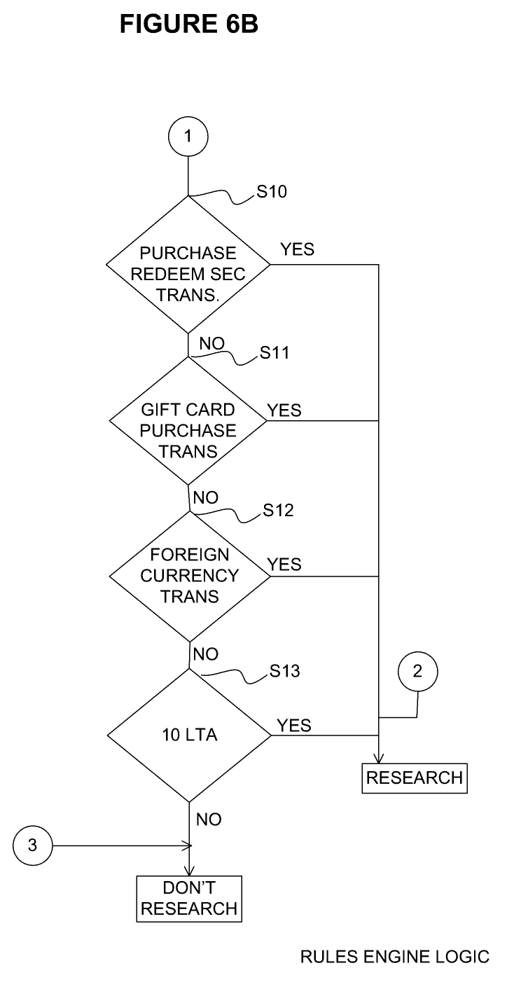

FIGS. 6A and 6B illustrate an exemplary operation of the protocol implemented by the Rules Engine 110. First, the Rules Engine 110 determines whether the transaction underlying the CTR 4 generated by the Financial Institution 31 was actually multiple non-sequential transactions that, in sum, are greater than a threshold value (step 51). If the Rules Engine 100 determines that the underlying transactions was actually multiple non-sequential transactions that, in sum, are greater than a threshold value, the Rules Engine 110 determines whether the underlying transaction was an S/H Coded Transaction (step S3). If the Rules Engine 110 determines that the underlying transaction was an S/H Coded Transaction, then the Rules Engine 110 determines whether: the underlying transaction was a “cash on us” transaction (step S5). If the Rules Engine 110 determines that the underlying transaction was a “cash on us” transaction, the Rules Engine 110 separates out the particular CTR 4, for further research. If the Rules Engine 100 determines that the underlying transaction was not a “cash on us” transaction, or an S/H coded transaction, the Rules Engine 110 then determines whether the underlying transaction was matched online and not in sequence (step S7). If the Rules Engine 110 determines that the underlying transaction was Matched online and not in sequence, then the Rules Engine 110 separates out the particular CTR 4 for further research (see FIG. 6B). Otherwise the Rules Engine 110 determines that the CTR 4 does not require further research, and allows the CTR 4 to be moved into the queue for filing with the Regulatory Agency 2 (see FIG. 6B).

If the Rules Engine 110 determines that the underlying transaction was multiple non-sequential transactions that, in sum, are greater than a threshold value (step S1), then the Rules Engine 110 determines whether the CTR 4 does not include a customer number (step S2), is a “cash advance transaction” (step S4), is a “cash on us” transaction (step S6), is a VLS/ALTELL loan debit transaction (step S8), a “coin counter” transaction (step S9), a purchase/redeem securities” transaction (step S10), a “gift card purchase” transaction (step S11), a “foreign currency” transaction, (step S12), or an IOLTA (Interest On Lawyer Trust Account) by TIN (Tax Identification Number) transaction (step S13). If the Rules Engine 110 determines that any of steps S4, S6, S8, S9, S10, S11, S12, or S13 is true, then the Rules Engine 110 separates the CTR 4 for further research (see FIG. 6B). Otherwise the Rules Engine 110 determines that the CTR 4 does not require further research, and allows the CTR 4 to be moved into the queue for filing with the Regulatory Agency 2.

In this exemplary embodiment, a “cash-advance transaction” is a cash withdrawal from a credit card. A “cash on us” transaction is currency drawn on the bank. A “VLS/ALLTEL loan debit transaction is a currency withdrawal from a line of credit. A “coin counter” transaction is a deposit of coins counted by a machine. A “purchase/redeem securities transaction is the purchase of bond (e.g., savings bonds) with currency. A “foreign currency” transaction is a deposit of foreign currency. A IOLTA by TIN, is a withdrawal from one or more IOLTA accounts linked by a TIN.

Although each exemplary operations with reference to FIGS. 5, 6A and 6B of the Currency Transaction Reporting System 10 recites steps performed in a particular order, the present invention does not necessarily need to operate in that recited order. One of ordinary skill in the art would recognize many variations, including performing steps in a different order.

The components shown in FIGS. 1 to 4 may be or include a computer or multiple computers. Although the components are shown as discrete units, all components may be interconnected or combined. The components may be described in the general context of computer-executable instructions, such as program modules, being executed by a computer. Generally, program modules include routines, programs, objects, components, data structures, etc. that perform particular tasks or implement particular abstract data types.

There are numerous other arrangements and applications then these few examples.

Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

The computer system may include a general purpose computing device in the form of a computer including a processing unit, a system memory, and a system bus that couples various system components including the system memory to the processing unit.

Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, the BeOS™ operating system, the Macintosh™® operating system, the Apache™ operating system, an OpenStep™ operating system or another operating system of platform.

At a minimum, the memory includes at least one set of instructions that is either permanently or temporarily stored. The processor executes the instructions that are stored in order to process data. The set of instructions may include various instructions that perform a particular task or tasks, such as those shown in the appended flowcharts. Such a set of instructions for performing a particular task may be characterized as a program, software program, software, engine, module, component, mechanism, or tool. The Currency Transaction Reporting system may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, REXX, and/or JavaScript for example. Further, it is not necessary that a single type of instruction or programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner Additionally, it is appreciated that each of the processor and/or memory may be composed of different physical pieces of equipment.

A user may enter commands and information into the computer through a user interface that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

One or more monitors or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Various networks may be implemented in accordance with embodiments of the invention, including a wired or wireless local area network (LAN) and a wide area network (WAN), wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Although many other internal components of the computer are not shown, those of ordinary skill in the art will appreciate that such components and the interconnections are well known. Accordingly, additional details concerning the internal construction of the computer need not be disclosed in connection with the present invention.

1. A currency transaction reporting system for accurately and efficiently creating supported currency transaction reports that operates over a telecommunications network, the system comprising:
at least one non-transitory storage device for storing data and instructions; and
at least one computer processor accessing the data and instructions stored at said non-transitory storage device, comprising:
a first database that organizes and stores on a computer readable medium one or more currency transaction reports, the currency transaction reports for filing with another party, wherein the transactions underlying the currency transaction reports are multiple non-sequential transactions;
a rules engine connected to the first database by the telecommunications network, that receives and filters the one or more currency transaction reports from the first database and divides the one or more currency transaction reports into a first group and a second group, in accordance with rules stored on the rules engine implemented in at least one of hardware and software, wherein the currency transaction reports in both the first group and the second group require further research;
a load balancing engine connected to the rules engine by the telecommunications network, that receives the one or more currency transaction reports of the first group or the second group and assigns, to one or more workstations, the one or more currency transaction reports of the first group or the second group based on a difficulty level of researching the one or more currency transaction reports, wherein the difficulty level of at least one currency transaction report in the first group is different than the difficulty level of at least one currency transaction report in the second group; and
a research engine connected to the rules engine by the telecommunications network, that generates research notes and supporting documentation for the one or more currency transaction reports of the first group or the second group;
wherein the one or more workstations receive the assigned one or more currency transaction reports for one or more users to electronically attach the research notes and supporting documentation to the one or more currency transaction reports to create one or more supported currency transaction reports which are filed with another party and archived;
wherein access to the one or more currency transaction reports, research notes, and supporting documentation is controlled.

2. The currency transaction reporting system that operates over a telecommunications network according to claim 1, wherein the rules engine divides the one or more currency transaction reports into the first group and the second group based on an underlying transaction of the one or more currency transaction reports.

3. The currency transaction reporting system that operates over a telecommunications network according to claim 2, wherein the research engine determines whether the underlying transaction is greater than a threshold amount.

4. The currency transaction reporting system that operates over a telecommunications network according to claim 2, wherein the underlying transaction is a cash-on-us transaction.

5. The currency transaction reporting system that operates over a telecommunications network according to claim 2, wherein the underlying transaction is a series of transactions.

6. (canceled)

7. The currency transaction reporting system that operates over a telecommunications network according to claim 2, wherein the underlying transaction is a VLS/ALTELL loan debit transaction.

8. The currency transaction reporting system that operates over a telecommunications network according to claim 2, wherein the underlying transaction is a coin-counter transaction.

9. The currency transaction reporting system that operates over a telecommunications network according to claim 2, wherein the underlying transaction is a purchase securities or redeem securities transaction.

10. The currency transaction reporting system that operates over a telecommunications network according to claim 2, wherein the underlying transaction is a gift-card purchase transaction.

11. The currency transaction reporting system that operates over a telecommunications network according to claim 2, wherein the underlying transaction is a foreign currency transaction.

12. The currency transaction reporting system that operates over a telecommunications network according to claim 2, wherein the underlying transaction is an IOLTA T.I.N. transaction.

13. The currency transaction reporting system that operates over a telecommunications network according to claim 1, further comprising an archive database.

14. The currency transaction reporting system that operates over a telecommunications network according to claim 1, further comprising a log database.

15. The currency transaction reporting system that operates over a telecommunications network according to claim 1, wherein the load balancing engine comprises a workstation queue, a control unit, and an assignment unit.

16. The currency transaction reporting system that operates over a telecommunications network according to claim 15, wherein the workstation queue includes one or more queues of workstations ordered by the control unit.

17. The currency transaction reporting system that operates over a telecommunications network according to claim 16, wherein the control unit orders the one or more queues according to a protocol.

18. The currency transaction reporting system that operates over a telecommunications network according to claim 17, wherein the protocol is a round robin protocol.

19. The currency transaction reporting system that operates over a telecommunications network according to claim 17, wherein the protocol is a weighted round robin protocol.

20. The currency transaction reporting system that operates over a telecommunications network according to claim 19, wherein the protocol is a priority protocol based on one or more of an average research time of a work station, a current load of a work station, a quality rating of a workstation, a relevant work history of a work station, a geographic location of a work station.

21. The currency transaction reporting system that operates over a telecommunications network according to claim 1, wherein the one or more workstations operate within a secure environment.

22. The currency transaction reporting system that operates over a telecommunications network according to claim 21, wherein the one or more workstations are computers, and running on the computer within the secure environment are one or more of a graphical user interface, tools, and an attachment unit.

23. The currency transaction reporting system that operates over a telecommunications network according to claim 21, wherein the workstations are connected to a private database.

24. The currency transaction reporting system that operates over a telecommunications network according to claim 21, wherein the workstations are connected to a public database.

25. The currency transaction reporting system that operates over a telecommunications network according to claim 22, wherein the attachment processing unit produces supports currency transaction reports through an electronic attachment process.

26. The currency transaction reporting system that operates over a telecommunications network according to claim 25, wherein the electronic attachment process includes electronically attaching one or more notes to the one or more currency transaction reports.

27. The currency transaction reporting system that operates over a telecommunications network according to claim 25, wherein the electronic attachment process includes electronically attaching one or more supporting documents to the one or more currency transaction reports.

28. The currency transaction reporting system that operates over a telecommunications network according to claim 1, further comprising a supporting document data base.

29. A computer implemented method for accurately and efficiently creating supported currency transaction reports, the currency transaction report for filing with another party, the method comprising:
at least one non-transitory storage device for storing data and instructions; and
at least one computer processor accessing the data and instructions stored at said non-transitory storage device, and executing instructions to perform steps including:
receiving the currency transaction reports and the currency transaction reports into a first group and a second group, in accordance with rules stored on a rules engine, wherein the currency transaction reports in both the first and the second group require further research, and further wherein the transactions underlying the currency transaction reports are multiple non-sequential transactions;
assigning, in accordance with rules stored on the rules engine implemented in at least one of hardware and software, to one or more computers, the currency transaction reports of the first group or the second group based on a difficulty level of researching the currency transaction reports, wherein the difficulty level of at least one currency transaction report in the first group is different than the difficulty level of at least one currency transaction report in the second group; and
electronically attaching by a first computer controlled by a user that receive the assigned currency transaction reports, one or more of user-identified notations and support documents to the currency transaction reports to create the supported currency transaction reports; and
filing the supported currency transaction report with another party and archiving the supported currency transaction report.

30. The computer implemented method for preparing a supported currency transaction report according to claim 29, wherein electronically attaching is completed within a secure environment.

31. The computer implemented method for preparing a supported currency transaction report according to claim 29, wherein the notations are based on information from a public database.

32. The computer implemented method for preparing a supported currency transaction report according to claim 29, wherein the notations are based on information from a private database.

33. The computer implemented method for preparing a supported currency transaction report according to claim 30, wherein the electronically attaching the one or more notations and support documents to the currency transaction report is initiated by a graphical user interface running on the first computer within the secure environment.

34. A computer implemented method for accurately and efficiently creating supported currency transaction reports, the currency transaction report for filing with another party, the method comprising:
at least one non-transitory storage device for storing data and instructions; and
at least one computer processor accessing the data and instructions stored at said non-transitory storage device, and executing instructions to perform steps including:
receiving currency transaction reports and filtering the currency transaction reports into a first group and a second group, in accordance with rules stored on a rules engine, wherein the currency transaction reports in both the first and the second group require further research, and further wherein the transactions underlying the currency transaction reports are multiple non-sequential transactions;
assigning, in accordance with rules stored on the rules engine implemented in at least one of hardware and software, to one or more computers, the currency transaction reports of the first group or the second group based on a difficulty level of researching the currency transaction reports, wherein the difficulty level of at least one currency transaction report in the first group is different than the difficulty level of at least one currency transaction report in the second group; and
electronically attaching by a first computer one or more of user-identified notations and support documents to the currency transaction reports to create the supported currency transaction reports, wherein the supported currency transaction reports are filed with another party and wherein electronically attaching is completed within a secure environment, wherein the notations are based on information from a public database or a private database,
wherein the electronically attaching the one or more notations and support documents to the currency transaction report is initiated by a graphical user interface running on the first computer within the secure environment.
